(19) United States
(12) Patent Application Publication
(10) Pub. No.: US 2011/0229695 A1
(43) Pub. Date: Sep. 22, 2011

(54) ARTICLES HAVING METALIZING AND HOLOGRAPHIC EFFECTS

(76) Inventors: Stanley Michael Marcinkowski, Peabody, MA (US); Paul Amaat France, West Chester, OH (US)

(21) Appl. No.: 12/726,577

(22) Filed: Mar. 18, 2010

(51) Int. Cl. B32B 3/30; B05D 3/12

(52) U.S. Cl. 428/172; 427/355

(57) ABSTRACT

An article having a substrate with at least one ink layer in direct contact with at least a portion of the substrate. An acrylic polymer matrix layer is in direct contact with at least a portion of the ink layer. The acrylic polymer matrix layer has suspended aluminum platelets and at least one photoinitiator. At least a portion of the acrylic polymer matrix layer has a selectively embossed top surface with a pattern of fine grooves to create an optical effect.

### FIELD OF THE INVENTION

The present invention relates to articles having an image with a metalizing and holographic effect and methods of manufacturing articles having an image with a metalizing and holographic effect. Specifically, the present invention relates to methods of manufacturing articles having an image with a metalizing and holographic effect without the use of a laminated or hot stamped foil.

### BACKGROUND OF THE INVENTION

Commodities are commonly packaged in packaging material for sale. To improve the attractiveness of the packaged commodities on the shelf and also to provide information about the packaged commodities, colors, graphics, words, etc. are printed on the packaging material. Nowadays, since consumers usually have too many choices for each type of commodities at the store, various efforts have been made to improve the attractiveness and eye-catching effect of packaging material so that the packaged commodity could be easily found by the shopper.

For example, a packaging material of paper substrate which is treated to provide shiny and/or hologram-like effect is available in the market. Commercially, there are two methods to make this hologram-like effect on paper substrate. One method is to laminate a metalized holographic plastic film on a paper substrate. The other method is to coat a paper substrate with a thin layer of varnish and then emboss the varnish layer. The embossed varnish layer provides desirable holographic effect. For plastic film material, it is known that by directly embossing the polymeric film substrate, the embossed polymeric film substrate can provide a holographic effect due to the mechanical deformation of the film surface.

Conventional holographic effects are manufactured by slow embossing and casting processes that are separate from mainstream printing processes. For example, the processes may involve embossing onto pre-metalized materials or casting onto clear films and papers, and then metalizing the embossed materials. Packages created using these techniques are typically not recycled because the foil used to produce the holographic images is bonded to the substrate and must be removed in order to be recycled. This requires several additional processing steps and costly materials. It would be more efficient and less costly to form the hologram on the packaging material in line with the printing of other image and information onto the packaging material. A protective layer is often required over the hologram so the hologram does not rub off.

### SUMMARY OF THE INVENTION

In one aspect, the invention features, in general an article having a substrate, at least one ink layer in direct contact with at least a portion of the substrate, and an acrylic polymer matrix layer in direct contact with at least a portion of the ink layer. The acrylic polymer matrix layer has suspended aluminum platelets and at least one photoinitiator. At least a portion of the acrylic polymer matrix layer has a selectively embossed top surface with a pattern of fine grooves to create an optical effect.

In another aspect, the invention features, in general, a method of applying an optical effect to a substrate by providing a substrate and applying at least one layer of ink directly on the substrate. A wet layer of acrylic polymer matrix having suspended aluminum particles and at least one photoinitiator is applied on the ink layer. The wet layer of acrylic polymer matrix is directly embossed with a casting film. The casting film and the wet layer of acrylic polymer matrix are maintained in constant and direct contact as the wet acrylic polymer matrix layer is cured with a curing lamp through the casting film to form a finished dry article. The casting film is then removed from the finished dry article.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings.

FIG. 1 is a top view of an article having an image with a metalizing holographic effect.

FIG. 2A is a schematic cross-sectional view of an embossed image of FIG. 1.

FIG. 2B is a schematic cross-sectional view of a non embossed image of FIG. 1.

FIG. 3 is a schematic view of one possible embodiment of a printing process for providing the article of FIG. 1.

FIG. 4A is a top view of another possible embodiment of an article having an image with a metalizing holographic effect.

FIG. 4B is an enlarged view of a portion of the article of FIG. 4A.

### DETAILED DESCRIPTION OF THE INVENTION

The present processes produce a hologram image directly on the package surface solely through printing steps. Further, no subsequent metalizing steps are required. Such steps which usually involve the vapor deposition of a metal, such as aluminum, onto a hologram surface are relatively slow as compared to printing techniques and require specialized equipment. In the present processes a hologram image is produced on a substrate solely through the use of printing techniques and equipment.

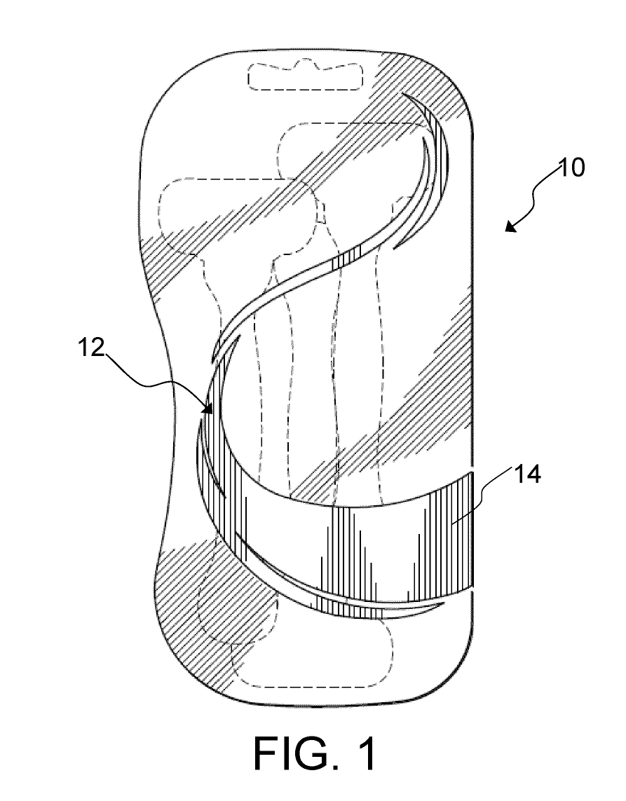

Referring to FIG. 1, a top view of one possible embodiment of an article 10 having a printed image 12 with one or more metalizing holographic effects 14 is illustrated. The article 10 may include, but not limited to, a label (e.g., pressure sensitive adhesive label), a thermoformed blister, a paperboard card, or a polymeric sheet or film. When light hits the interface between air and the article, a certain percentage of the light is reflected, depending on the properties of the article 10. For example, more light will be reflected off of a metallic surface (e.g., the metalizing holographic effect 14). The direction and amount of light reflected from a surface may also depend on the surface texture of the article 10. For example, a series of fine lines and grooves on the printed image 12 may result in an optical or holographic effect.

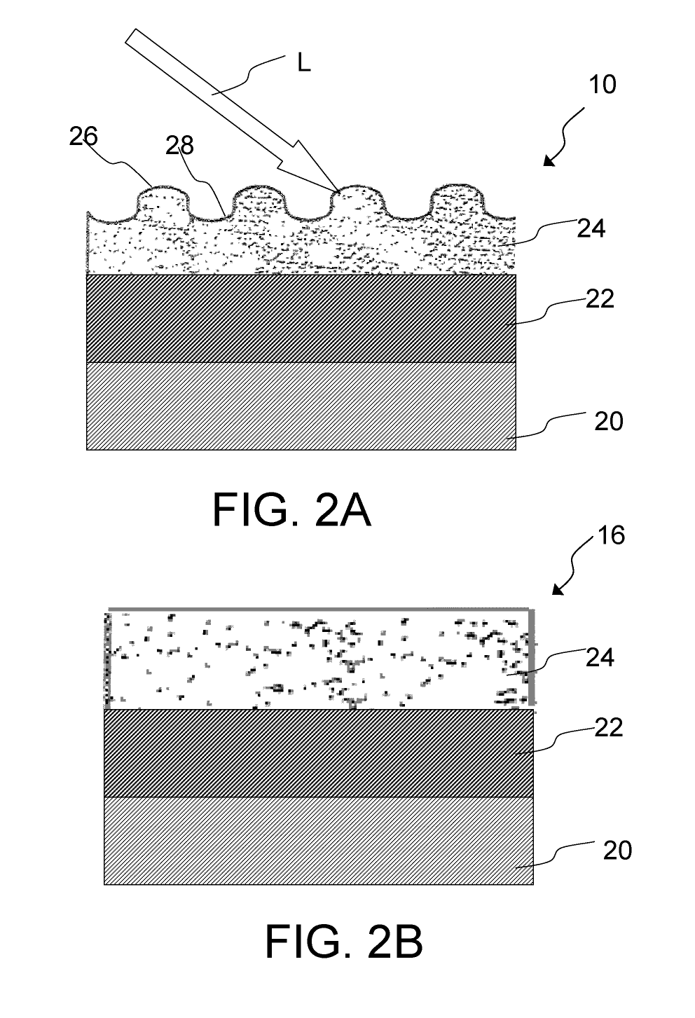

FIG. 2A illustrates a schematic cross-sectional view of the metalizing holographic effect 14 of the article 10 shown in FIG. 1. The metalizing holographic effect 14 may comprise several layers depending on the desired optical appearance of the article 10. A substrate 20 may comprise a base or bottom layer of the metalizing holographic effect 14. The substrate may include, but is not limited to, various grades of paper (e.g. about 0.025 mm, 0.05 mm, or 0.075 mm to about 0.80 mm, 0.10 mm, or 0.127 mm in thickness) and paperboard (e.g. about 0.25 mm, 0.50 mm, or 0.75 mm to about 1.0 mm, 1.25 mm, or 1.5 mm in thickness), polymer films, polymer shrink wrap films, biodegradable polymer films, or thermoform polymer sheet stock for blister pack applications. Other substrates may also be used such as, those created from recycled materials. The sheet stock may have a thickness of about 0.25 mm to about 1.25 mm. The substrate may be transparent and opaque and may be any color, including black and white. It will be understood that the term “substrate” as used herein refers to plastic, paper, cardboard, metal, or any other flexible material utilized by those in the graphic arts printing industry.

One or more ink layers 22 may be deposited directly on the substrate 20 to produce a first colored image. The ink layer 22 may be deposited directly on the substrate 20 as the substrate 20 is pulled through a series of stations, or print units. Each print unit may print a single color. The ink layer 22 may be the same color or a different color than the substrate 20. The inks may be deposited selectively in certain areas on the top surface of the substrate 12 to create the first image. The various tones and shading may be achieved by overlaying the four basic shades of ink: magenta, cyan, yellow and black. Magenta provides red tones and cyan provides blue tones. Each ink station may be followed immediately by a curing station with a UV lamp, which then may be followed by a varnish or lacquer coating (e.g., UV, water based, or solvent based). The varnish or lacquer coating may then pass to a curing or drying station depending on the coating requirements.

Ultraviolet (UV) and Electron Beam (EB) curable inks may also be used for printing. The use of UV curable inks may provide improved quality for applications that require overprint of inks or coatings. Electron beam curing inks may also be used. Electron beam curing inks typically require less energy than ultraviolet curing inks, but also typically have a higher capital cost.

If a desired image requires a metalizing effect, typically foil must be used. Foil stamping or laminating is typically used in commercial printing processes to produce metalized effects. It can be used to produce three dimensional holographic metalized effects. Foil stamping involves the application of pigment or metallic foil, often gold or silver, but can also be various patterns or what is known as pastel foil which is a flat opaque color or white a special film-backed material, to paper where a heated die is stamped onto the foil, making it adhere to the surface leaving the design of the die on the paper. The temperature of the heated dies limits the application of foil stamping or lamination to paper and paperboard substrates because the temperature and/or pressure may damage polymer substrates. The application of foil also limits secondary processes, such as thermoforming the substrate because the foil splinters, cracks, or delaminates from the substrate. Another limitation of foil is that the application of foil to the substrate must be done offline and before applying ink to the substrate because the equipment for applying foil is not compatible with standard printing press equipment.

A final acrylic polymer matrix layer 24 may be applied directly to the ink layer 22 and/or the substrate 20. The acrylic polymer matrix layer 24 may produce “foil-like” or metalizing effects that may cover only specific portions (i.e., spot coating) or the entire upper surface of the substrate 20 and/or ink layer 22. The acrylic polymer matrix layer 24 may comprise a mixture of an acrylic polymeric matrix of medium molecular weight, a mixture of reactive diluents and at least one photoinitiator. Aluminum particles may be suspended in the mixture to provide a foil appearance to the polymer matrix layer 24. The acrylic polymer matrix layer 24 may also include reactive diluents (e.g., acrylate monomers, vinyl acetate monomers, epoxy acrylates, or any combination thereof) to thin the mixture and facilitate coating. The reactive diluents may also improve the toughness, durability, scratch resistance, and/or chemical resistance. The polymeric matrix may provide an inert matrix to support the aluminum particles, photoinitiator, and the reactive diluents. The polymeric matrix that suspends the aluminum particles may be transparent nature to improve metallic appearance of the acrylic polymer matrix layer 24. The suspended aluminum particles may include platelets to improve the metalizing effect of the final printed article 10. High shear mixing of the acrylic polymer matrix may cause breakage of the aluminum platelets resulting in loss brilliancy. The acrylic polymer matrix may be mixed via tumbling or applying gentle, low speed stiffing with up and down flow motion with proper mixing blade or with speculator by hand. Chemicals that have a potential of corroding aluminum metal should be avoids during the printing process, such as high acidic or basidic chemicals.

In certain embodiments, the acrylic polymer matrix layer may be in direct contact with at least a portion of the substrate and/or the ink layers. At least a portion of the acrylic polymer matrix layer 24 may be transparent or translucent to allow the ink layer 22 to be visible through the acrylic polymer matrix layer 24, which may allow the ink layer 22 and the acrylic polymer matrix layer 24 to be cured simultaneously. The acrylic polymer matrix layer 24 may be applied to the substrate 20 either before or after the ink layer 22 has been laid down on the substrate 20. The acrylic polymer matrix layer 24 may have a thickness of about 1 micron, 10 microns, or 20 microns to about 50, 75, or 100 microns. In certain embodiments, the acrylic polymer matrix layer 24 may have a coating weight that is about 1.5 times to about 2 times greater than traditional hot stamping foils, which may result in a reduction in material usage. For example, the coating weight for the acrylic polymer matrix layer 24 may be about 2.0 μm to about 3.0 μm and the coating weight for traditional hot stamping foils may be about 4.0 μm to about 6.0 μm. In certain embodiments, the coating weight for the acrylic polymer matrix layer 24 may be about 2.6 μm.

The acrylic polymer matrix layer 24 may be applied in line with the printing stations for the ink layers 22, thus the substrate 20 with the required images can be produced in a continuous manner. In one embodiment, MiraFoil™ supplied by Henkel under the designation L9213SL may be used for the acrylic polymer matrix layer 24. MiraFoil™ is an ultraviolet aluminium physical vapor deposition dispersion coating. MiraFoil™ is a UV curable and coatable foil replacement system that delivers “foil-like” appearance to substrates such as coated paper, paperboard and print treated plastic films. The UV aluminum physical vapor deposition dispersion coating eliminates the need to send items out for lamination thus reducing lead-times on materials. This material also enhances the sustainability score with companies by allowing the paper or paperboard substrate to be recycled without separation of the laminated paper with foil because this is an ink applied during the printing process. MiraFoil™ may also be used with other substrates, such as polymer films and sheets to produce a metallic effect without damaging the substrate. Once the acrylic polymer matrix layer 24 is applied, no additional coatings (e.g., a varnish layer) are needed because the coating cures faster and stronger than typical base UV inks.

A top surface 26 of the acrylic polymer matrix layer 24 may be embossed with a plurality of grooves 28. The grooves 28 may be uniformly spaced apart by about 0.10 microns, 0.5 microns or 1 micron to about 4 microns, 6 microns, or 10 microns. The grooves 28 may also be at least 0.01 microns deep to create an optical effect. The top surface 26 of the acrylic polymer matrix layer 24 diffracts incoming light “L” by dividing the light into its component colors. The colors propagate off of the top surface 26 of the acrylic polymer matrix layer 24 in different directions to create an optical effect (e.g, a holographic effect).

FIG. 2B illustrates a schematic cross-sectional view of a non-embossed article 16. The non-embossed article is the same as the schematic cross-sectional view of the metalizing holographic effect 14 of the article 10 shown in FIG. 1, but prior to embossing. The polymer acrylic matrix layer 24 may be the top or outer most layer of the printed article 10 just prior to embossing. The polymer acrylic matrix layer 24 eliminates the need of a varnish layer prior to embossing because it has been shown that the acrylic matrix layer 24 does not adhere to various casting films.

Embossing or emboss as used herein refers to a process of creating a three-dimensional image or pattern on a substrate, such as paper, a polymeric film or other ductile materials. The embossing process imparts unevenness imperceptible to unaided human eyes on the treated surface of a substrate. Such imperceptible unevenness provides a hologram-like effect to unaided human eyes under light. In a preferred embodiment, the embossed imperceptible pattern is paralleled and equally spaced fine grooves. Embossing treatment of a polymeric film substrate is well known in the art and is typically accomplished with a combination of heat and pressure on the polymeric film substrate. The embossing step of the present invention can be conveniently conducted by any known method in the art.

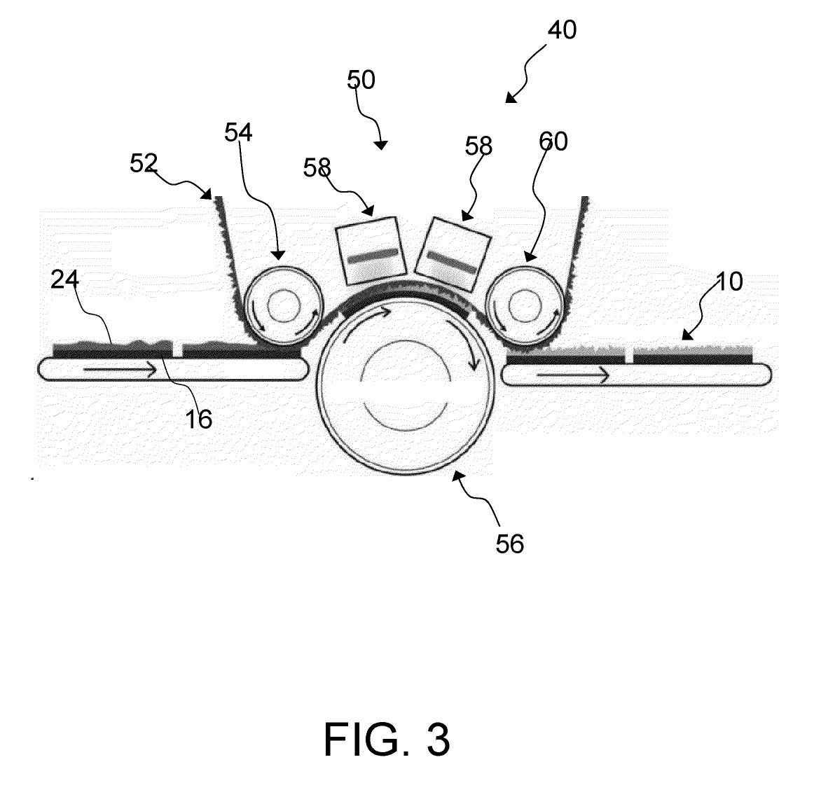

Referring to FIG. 3, a schematic view of one possible embodiment of a decorative coating process 40 is shown. The decorative coating process 40 integrates “casting” and “curing” techniques to form a consistent high quality surface with metalizing and holographic effects. The non-embossed article 16 may be either sheet-fed or web-fed into a casting station 50. The non-embossed article 16 may have been previously coated with the acrylic polymer matrix layer 24 and the one more ink layers 22, as previously described. Sheet-fed refers to the substrate, such as paper or paperboard being fed into a press one unit at a time at a very high speed. Sheet-fed printing is commonly used for printing of short-run magazines, brochures, letter headings, and general commercial printing. Web-fed presses print on a continuous roll of substrate, or web, which is later cut to size.

The casting station 50 eliminates the need for holographic foil lamination or hot/cold stamping by embossing step for embossing directly on the acrylic polymer matrix layer 24 without the use of a varnish layer. The casting station 50 may include a casting film 52, a first nip roller 54, an impression cylinder 56, one or more curing lamps 58 (e.g., ultraviolet or electron beam lamps), a second nip roller 60. A preferred embossing method for use in the present invention is known as “soft embossing”. “Soft embossing” is a process by which the casting film 52 may be embossed at a pressure of about 200 psi so as to emboss only one side of the film and leave the opposite side of the film essentially untouched. The resulting embossed casting film 52 is embossed on one side with desired finishes and/or decorative design images, such as, a pattern of fine grooves to create an optical effect on the printed article 10. Depending on the desired finish, different films can be used, including transparent film, gloss film, holographic film, or any such film with an embossed design. The casting film 52 with the embossed image is reusable and recyclable, thus reducing costs and the amount of material required to manufacture a large quantities of printed articles. In certain embodiments, the casting film 52 may be a biaxial orientated polypropylene film that is continuously re-used about 5 times, 7 times, or 10 times to about 15 times, 20 times, or 30 times. It is understood that the casting film may emboss only on the acrylic polymer matrix layer 24 or directly on the ink layer 22 and the acrylic polymer matrix layer 24.

The first nip roller 54 may bring the casting film 52 into direct contact with the acrylic polymer matrix layer 24. The acrylic polymer matrix layer 24 may be wet to facilitate embossing by the casting film 52. The casting film 52 and the acrylic polymer matrix layer 24 may remain in contact as they pass from the first nip roller 54 to the impression cylinder 56. The casting film 52 may remain in direct and constant contact with the acrylic polymer matrix layer 24 as ultraviolet light from the curing lamps 58 is used to cure the coated surface of the printed article 10. The lamp energy of the ultraviolet light may be about 400 watts to about 600 watts. The ultraviolet light is applied to the coated surface while the casting film 52 is laminated on top of it, resulting in the desired finish or design image being fixed on the printed article 10. No additional coatings are required because the acrylic polymer matrix layer 24 comprises at least one photoinitiator. In certain embodiments, the ink layer 22 and the acrylic polymer matrix layer 24 may be cured simultaneously by the curing lamps 58

After the ultraviolet curing has been finished, the second nip roller 60 may facilitate the removal of the casting film 52 from the printed article 10. The finished printed article 10 may then be moved to a stacking unit. The stacking unit is where all of the completed printed articles 10 are collected after the decorative coating process 40 has been applied. Alternatively, the printed articles 10 may pass to additional secondary stations, such as, printing, coating, and cutting stations. The decorative coating process 40 may result in a cured holographic image that does not require any additional coatings (e.g., a UV varnish layer) because the polymer acrylic matrix layer 24 is sufficiently hardened such that the ink layer 22 and the acrylic polymer matrix layer 24 do not rub off easily. The elimination of the need of an additional layer (e.g., a UV varnish layer) significantly reduces costs and cycle times.

The decorative coating process 40 illustrated in FIG. 3 may be applied to an entire surface of the acrylic polymer matrix layer 24, or may be applied to local areas of the acrylic polymer matrix layer 24. The decorative coating process 40 is very environmentally friendly because ultraviolet inks and coatings are used which do not contain undesirable and harmful volatile organic compounds (VOCs). Furthermore, articles manufactured by the decorative coating process 40 are more easily recycled because laminated or stamped metalized foils are eliminated and thus do not have to be separated from the substrate 20 prior to recycling.

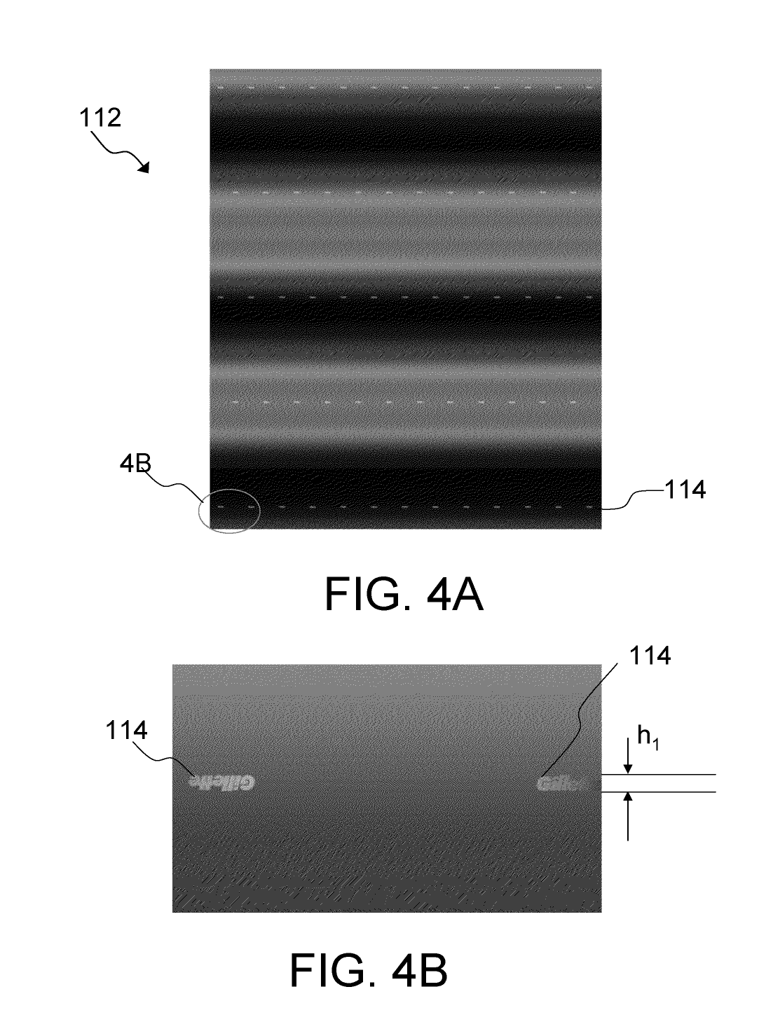

FIGS. 4A and 4B illustrates another possible embodiment of a printed image 112 with one or more metalizing holographic effects 114. The printed image 112 may be used in almost any package configuration including, but not limited to, a label (e.g., pressure sensitive adhesive label), a thermoformed blister, a paperboard card, or a polymeric sheet or film. The metalizing holographic effect 114 may be produced the same way as the metalizing holographic effect 14, as previously described. The metalizing holographic effect 114 may be utilized to detect counterfeit packaging. The metalizing holographic effect 114 may not be visible to the unaided human. Accordingly, packages having containing counterfeit products will not have the metalizing holographic effect 114 because the counterfeiter would lack the technology to reproduce the metalizing holographic effect 114 or properly reproducing the metalizing holographic effect 114 with foil stamping or foil lamination may prove to be too costly or difficult. For example, foil stamping may leave a mark or impression around the holographic effect. Furthermore, a foil stamping die may not be able to be manufactured having a holographic effect with very small details. The metalizing holographic effect 114 may have a selectively embossed upper surface with a pattern of fine grooves to create an optical effect having a width “w₁” of about 0.10 mm, 0.15 mm, 0.20 mm to about 0.25 mm, 0.35 mm, 0.45 mm. The metalizing holographic effect 114 may be a series of repeating digits (i.e., letters or numbers) that are part of the printed image 112. The metalizing holographic effect 114 may also occur randomly as part of the printed image 112. As shown in FIG. 4B, the metalizing holographic effect 114 may be a name (such as “Gillette”) that is arranged in repeating rows; however the orientation of the name “Gillette” may alternate. Shapes and symbols may also be used as the metalizing holographic effect 114 to identify counterfeit products.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An article comprising:
a substrate;
at least one ink layer in direct contact with at least a portion of the substrate and;
an acrylic polymer matrix layer in direct contact with at least a portion of the ink layer, the acrylic polymer matrix layer having suspended aluminum platelets and at least one photoinitiator, wherein at least a portion of the acrylic polymer matrix layer has a selectively embossed top surface with a pattern of fine grooves to create an optical effect.

2. The article of claim 1 wherein embossed top surface of acrylic polymer matrix layer is devoid of an additional varnish layer.

3. The article of claim 1 wherein the layer of acrylic polymer matrix comprises at least one additional group of metallic particles.

4. The article of claim 1 wherein the embossed top surface of the acrylic polymer matrix layer is devoid of an additional UV curable layer.

5. The article of claim 2 wherein the ink layer and the acrylic polymer matrix layer are cured simultaneously.

6. The article of claim 4 wherein the acrylic polymer matrix layer has a thickness of about 1 micron to about 100 microns.

7. The article of claim 6 wherein the pattern of fine grooves is a series of repeating digits having a width of about 0.10 mm to about 0.45 mm.

8. The article of claim 4 wherein the grooves are uniformly spaced apart by about 0.10 microns to about 10 microns.

9. The article of claim 4 wherein the grooves are at least 0.01 microns deep.

10. The article of claim 4 wherein at least a portion of the acrylic polymer matrix layer is transparent.

11. The article of claim 4 wherein in the substrate is flexible.

12. The article of claim 11 wherein in the substrate comprises a polymeric film.

13. The article of claim 4 wherein the substrate is rigid.

14. The article of claim 13 wherein the substrate comprises paperboard.

15. The article of claim 13 wherein the substrate comprises a polymeric sheet having a thickness of about 0.25 mm to about 1.5 mm.

16. A method of applying an optical effect to a substrate comprising the steps of:
providing a substrate;
applying at least one layer of ink directly on the substrate;
applying a wet acrylic polymer matrix layer having suspended aluminum particles and at least one photoinitiator on the substrate;
embossing directly onto the wet acrylic polymer matrix layer with a casting film;
maintaining constant and direct contact between the casting film and the wet acrylic polymer matrix layer while curing the wet acrylic polymer matrix layer through the casting film to form a finished dry article; and
removing the casting film from the finished dry article.

17. The method of claim 16 wherein the casting film is a transparent biaxial orientated polypropylene film.

18. The method of claim 16 further comprising curing the ink layer and the wet acrylic polymer matrix layer simultaneously.

19. The method of claim 16 wherein the substrate is coated with the wet acrylic polymer matrix layer immediately after applying the layer of ink.

20. The method of claim 16 wherein the casting film is continuously reused about 5 to about 30 times.
